(19) United States
(12) Patent Application Publication
(10) Pub. No.: US 2013/0106322 A1
(43) Pub. Date: May 2, 2013

(54) DIAL SWITCH FOR MOTOR CONTROL

(71) Applicant: Edward L. Drye, Troy, OH (US)

(72) Inventor: Edward L. Drye, Troy, OH (US)

(21) Appl. No.: 13/285,741

(22) Filed: Oct. 31, 2011

(51) Int. Cl. G05B 19/02

(52) U.S. Cl. 318/162

(57) ABSTRACT

A motor assembly includes an electric motor having a stator and a rotor. A housing is coupled to the electric motor. A motor controller is disposed within the housing. A human machine interface (HMI) is coupled to the housing and in communication with the motor controller for user control of the electric motor. The HMI includes a rotatable user input providing simultaneous mode selection and mode indication.

### BACKGROUND

The invention relates to electric motors. More specifically, the invention relates to a human-machine interface for electric motors.

Variable speed electric pump motors have come into common usage due to efforts to reduce energy by operating motors at lower speeds when practical. A programmable timer commands a motor controller to follow a speed profile. The speed profile is programmed into a human-machine interface by a user.

### SUMMARY

In one embodiment, the invention provides a motor assembly including an electric motor having a stator and a rotor. A housing is coupled to the electric motor. A motor controller is disposed within the housing. A human machine interface (HMI) is coupled to the housing and in communication with the motor controller for user control of the electric motor. The HMI includes a rotatable user input providing simultaneous mode selection and mode indication.

In another embodiment, the invention provides a human-machine interface (HMI) for communication with a motor controller for operating an electric motor in a plurality of operating modes. The HMI includes a housing having a display face. A display is coupled to the display face for display of operating parameters. A rotatable user input provides a simultaneous mode selection and mode indication.

In yet another embodiment, the invention provides a motor assembly including an electric motor having a stator and a rotor. A housing is coupled to the electric motor. A motor controller is disposed within the housing. A human machine interface (HMI) is selectively detachably coupled to the housing for user control of the electric motor when the HMI is coupled to the housing and for user control of the electric motor when the HMI is separately disposed from the housing to the housing. The HMI includes a display screen and a rotatable user input providing simultaneous mode selection and mode indication. An interface cord communicates user control inputs from the HMI to the motor controller.

Other aspects of the invention will become apparent by consideration of the detailed description and accompanying drawings.

### BRIEF DESCRIPTION OF THE DRAWINGS

FIG. 1 is a perspective view of a motor assembly.

FIG. 2 is a cross sectional view along section line 2-2 of the motor assembly of FIG. 1.

FIG. 3 is a perspective view of a motor assembly with a human-machine interface remotely disposed.

FIG. 4 is a top view of the human machine interface.

FIG. 5 is a block diagram of the motor assembly.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

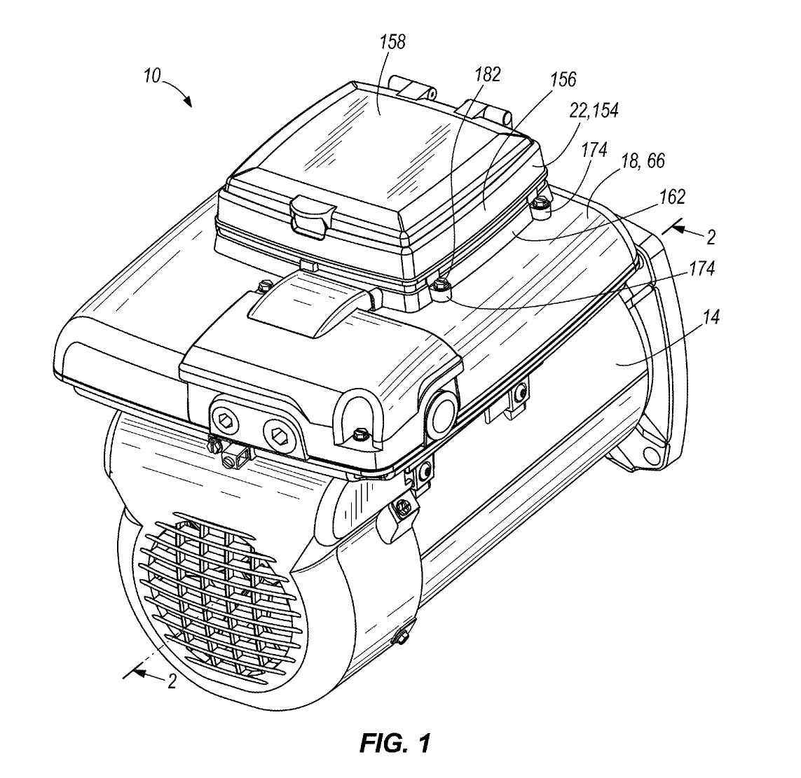

FIG. 1 illustrates a motor assembly 10, such as for use with a pump. The motor assembly 10 includes an electric motor 14, a motor control module 18, and a human machine interface (HMI) 22. The motor assembly 10 may be, for example, an electronically controlled, variable speed pump motor.

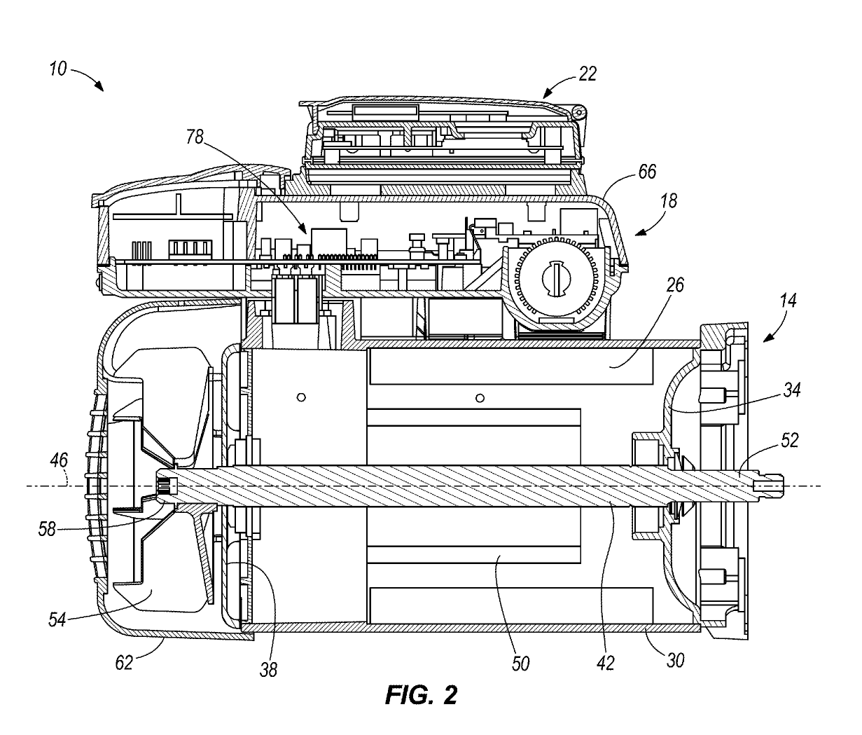

Referring to FIG. 2, the electric motor 14 includes a stator 26 disposed within a stator housing 30. A first end frame 34 and a second end frame 38 are coupled to the stator housing 30. A rotor shaft 42 is rotatably coupled to the first end frame 34 and the second end frame 38 for rotation about an axis 46 within the stator 26. The rotor shaft 42 supports a rotor 50. The rotor 50 is operable to rotate with respect to the stator 26 as a result of applying a current through windings of the stator 26. A load end 52 of the rotor shaft 42, adjacent the first end frame 34, may be coupled to a pump or other load to be driven. A fan 54 is fixedly coupled to a fan end 58 of the rotor shaft 42, adjacent the second end frame 38. The fan 54 is disposed within a fan housing 62.

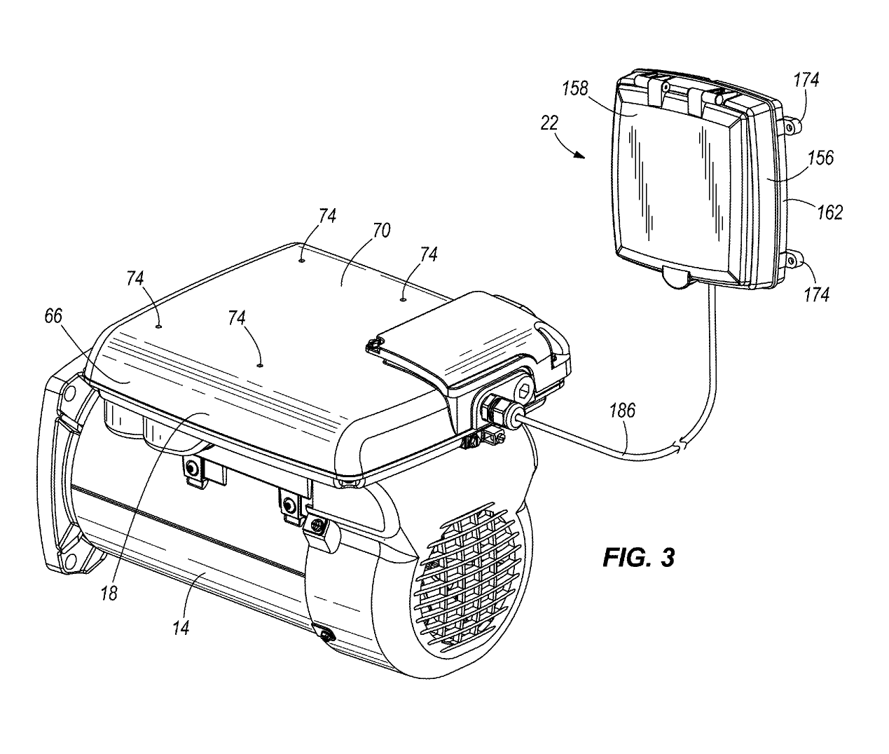

As shown in FIGS. 1-3, the control module 18 includes a controller housing 66. Referring to FIG. 3, planar surface 70 of the controller housing 66 defines four threaded apertures 74. Referring to FIG. 2, a motor controller 78 is disposed within the controller housing 66. The motor controller 78 may include a printed circuit board (PCB) as well as power electronics and overload circuitry that is integral to, or coupled to, the PCB.

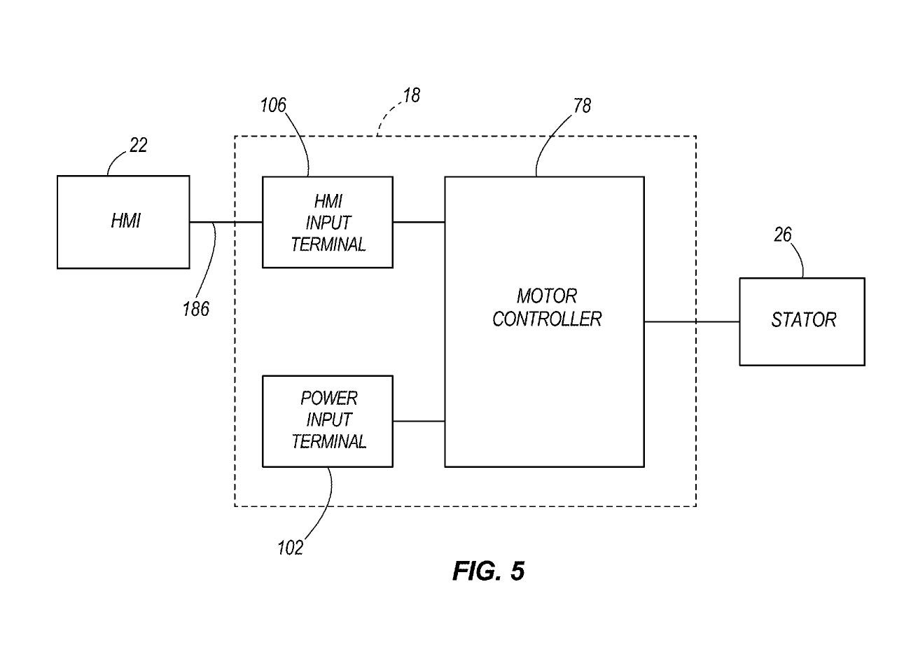

Referring to FIG. 5, power input terminals 102 and an HMI input terminal 106 are disposed within the controller housing 66 and connected to the motor controller 78. The HMI input terminal 106 is configured for communication between the HMI 22 and the motor controller 78.

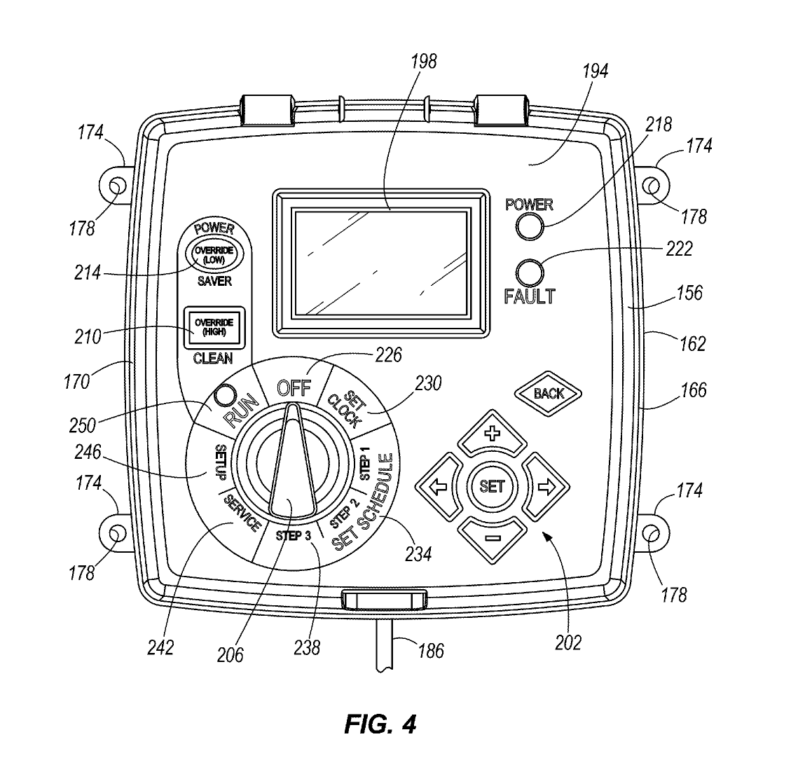

Referring back to FIG. 1, the HMI 22 includes an HMI housing assembly 154. The HMI housing assembly 154 includes an HMI base housing 156, an HMI cover 158, and an HMI mounting plate 162. The HMI mounting plate 162 is configured to receive the HMI base housing 156 and to couple the HMI base housing 156 to the controller housing 66. The HMI mounting plate 162 is generally in the shape of the HMI base housing 156, with a first sidewall 166 and a second sidewall 170. As best illustrated in FIG. 4, the HMI mounting plate 162 includes four foot members 174. Two foot members 174 extend from the first sidewall 166, while two more foot members 174 extend from the second sidewall 170. Each foot member 174 defines an aperture 178. The foot members 174 and apertures 178 are arranged in order to substantially align with the threaded apertures 74 of the controller housing 66 (FIG. 3) for mounting the HMI 22 to the control module 18. As shown in FIG. 1, fasteners 182 are provided in order to couple the HMI 22, via the HMI mounting plate 162, to the controller housing 66.

Referring now to FIG. 3, the HMI 22 may be detached from the controller housing 66 and mounted in a location remote from electric motor 14 and control module 18, such as an adjacent wall or nearby wall. The foot members 174 may be used, in conjunction with application-appropriate fasteners, to attach the HMI 22 to a wall or other surface. An interface cord 186 connects the HMI 22 to the interface terminal 106, in order to place the HMI 22 in communication with the motor controller 78.

FIG. 4 illustrates the HMI 22 with the HMI cover 158 detached. A control and display face 194 of the HMI 22 includes a display screen 198, parameter entry buttons 202, and a rotatable selection switch 206. The display screen 198 may include, for example, a liquid crystal display, for displaying program parameters such as speed and time. A high speed program override button 210 and a low speed program override button 214 are provided in order to override a current program setting and to command the electric motor to run at a prescribed high speed or low speed for a prescribed length of time. A power light 218 provides visual indication of power availability. A fault light 222 provides visual indication of a fault in the HMI or controller.

The rotatable switch 206 provides simultaneous mode selection and mode indication to a user, with the rotatable switch 206 selected to one of a plurality of predefined positions. With the rotary switch 206 in an off position 226, motor assembly 10 is off (i.e., no power is routed to the stator). A clock setting position 230 allows a user to set a clock of the HMI. A schedule programming position 234 includes three selectable steps 238 for programming a series of time and speed setting. A service position 242 is provided for maintenance and repair of the motor assembly. A setup position 246 provides for programming of the motor assembly during, for example, initial installation. The positions 230, 234, 242, and 246 are used in conjunction with the program entry and selection buttons to program the motor assembly. A run position 250 provides for operation of the motor assembly according to a programmed control sequence. The programmed control sequence is overridden by selection of either the high speed override button 210 or the low speed override button 214, with the rotatable switch selected to the run position 250.

The block diagram of FIG. 5 illustrates the interrelationships of the HMI 22, the motor controller 78, and the stator 26. Further discussion regarding an exemplary control of a motor 14, pump system, and pool system is described in U.S. Patent Application No. Attorney Docket No. 028460-8437 US00, filed on even date herewith, the entire content of which is incorporated herein by reference.

Thus, the invention provides, among other things, a new and useful motor assembly with a human machine interface. Various features and advantages of the invention are set forth in the following claims.

What is claimed is:

1. A motor assembly comprising:
an electric motor including a stator and a rotor;
a housing coupled to the electric motor;
a motor controller disposed within the housing; and
a human machine interface (HMI) coupled to the housing and in communication with the motor controller for user control of the electric motor, the HMI including a rotatable user input providing simultaneous mode selection and mode indication.

2. The motor assembly of claim 1, wherein the HMI is selectively detachably coupled to the housing for user control of the electric motor when the HMI is coupled to the housing and for user control of the electric motor when the HMI is separately disposed from the housing

3. The motor assembly of claim 2, wherein the HMI is coupled to the motor controller via an interface cord when separately disposed from the motor housing.

4. The motor assembly of claim 1, wherein the HMI includes a display screen.

5. The motor assembly of claim 2, wherein the HMI is coupled to the control module via the interface cord when coupled to motor housing.

6. The motor assembly of claim 1, wherein the rotatable user input is rotatable to a plurality of predefined mode selection and mode indication positions.

7. The motor assembly of claim 6, wherein the plurality of predefined mode selection and mode indication positions includes a schedule programming mode position.

8. The motor assembly of claim 6, wherein the plurality of predefined mode selection and mode indication positions includes a setup mode position.

9. The motor assembly of claim 6, wherein the plurality of predefined mode selection and mode indication positions includes a run mode position.

10. The motor assembly of claim 9, wherein the motor assembly executes a programmed operating schedule when the rotatable user input is selected to the run mode position.

11. The motor assembly of claim 10, wherein the HMI further comprises an override user input for overriding the programmed operating schedule when the rotatable user input is selected to the run mode position.

12. The motor assembly of claim 11, wherein the override user input include a first override user input for selecting a first electric motor operating speed and a second override user input for selecting a second electric motor operating speed.

13. A human-machine interface (HMI) for communication with a motor controller for operating an electric motor in a plurality of operating modes, the HMI comprising:
a housing including a display face;
a display coupled to the display face for display of operating parameters; and
a rotatable user input providing a simultaneous mode selection and mode indication.

14. The HMI of claim 13, wherein the rotatable user input is rotatable to a plurality of predefined mode selection and mode indication positions.

15. The HMI of claim 14, wherein the plurality of predefined mode selection and mode indication positions includes a schedule programming mode position.

16. The HMI of claim 14, wherein the plurality of predefined mode selection and mode indication positions includes a setup mode position.

17. The HMI of claim 14, wherein the plurality of predefined mode selection and mode indication positions includes a run mode position.

18. The HMI of claim 17, wherein the HMI communicates an operating schedule when the rotatable user input is selected to the run mode position.

19. The HMI of claim 18, further comprises an override user input for overriding the programmed operating schedule when the rotatable user input is selected to the run mode position.

20. The HMI of claim 19, wherein the override user input include a first override user input for selecting a first electric motor operating speed and a second override user input for selecting a second electric motor operating speed.

21. A motor assembly comprising:
an electric motor including a stator and a rotor;
a housing coupled to the electric motor;
a motor controller disposed within the housing;
a human machine interface (HMI) selectively detachably coupled to the housing for user control of the electric motor when the HMI is coupled to the housing and for user control of the electric motor when the HMI is separately disposed from the housing to the housing, the HMI including a display screen and a rotatable user input providing simultaneous mode selection and mode indication; and
an interface cord communicating user control inputs from the HMI to the motor controller.
